(19) United States
(12) Patent Application Publication
(10) Pub. No.: US 2007/0245052 A1
(43) Pub. Date: Oct. 18, 2007

(54) SYSTEM AND METHOD FOR BANDWIDTH SHARING IN BUSSES

(75) Inventors: Jing Jung HUANG, Taipei City (TW); Yi Chih HUANG, Hsinchu City (TW)

Correspondence Address: LOWE HAUPTMAN HAM & BERNER, LLP, 1700 DIAGONAL ROAD, SUITE 300, ALEXANDRIA, VA, 22314, US

(73) Assignee: REALTEK SEMICONDUCTOR CORP., Hsinchu (TW)

(21) Appl. No.: 11/735,976

(22) Filed: Apr. 16, 2007

(30) Foreign Application Priority Data
Apr. 17, 2006 (TW) 095113610

(51) Int. Cl. G06F 13/36

(52) U.S. Cl. 710/113

(57) ABSTRACT

A system for bandwidth sharing in busses comprises a shared bus, a timer for counting a predetermined period of time, a real-time master having a priority for using the shared bus, and a central processing unit having a priority higher than that of the real-time master for using the shared bus, wherein the central processing unit sends a predetermined number of bus request signals within the predetermined period of time for requesting the right for using the shared bus to transmit data. The present invention also provides a method for bandwidth sharing in busses.

### CROSS REFERENCE TO RELATED APPLICATION

This application claims the priority benefit of Taiwan Patent Application Serial Number 095113610, filed on Apr. 17, 2006, the full disclosure of which is incorporated herein by reference.

### BACKGROUND OF THE INVENTION

1. Field of the Invention

This invention generally relates to a system for bandwidth sharing in busses, and more particularly to a system for bandwidth sharing in busses with a central processing unit having the highest priority.

2. Description of the Related Art

FIG. 1 shows a circuit block diagram of a conventional system 10 for bandwidth sharing in a shared bus. The system 10 includes a central processing unit (CPU) 12, a memory unit 14, a plurality of masters 16a, 16b and 16c, a shared bus 18, and a bus arbiter 20. The central processing unit 12, the memory unit 14 and the plurality of masters 16a, 16b and 16c are connected to the shared bus 18, and transmit data through the shared bus 18. In addition, the bus arbiter 20 is for arbitrating the right for using the shared bus 18 among the central processing unit 12 and the masters 16a, 16b and 16c.

In general, a master having real-time processing needs, e.g. a master of a monitor or a DVD player, usually has a higher priority and a master having no real-time processing needs, e.g. a master of a hard disk, usually has a lower priority. In addition, the priority of the central processing unit 12 is generally lower than that of a master having real-time processing needs and higher than that of a master having no real-time processing needs.

In the system 10, the master 16a has real-time processing needs and thus has the highest priority, and the central processing unit 12 ranks the second, which is lower than that of the master 16a and higher than those of the masters 16b and 16c. When the central processing unit 12 and the masters 16a, 16b and 16c need the shared bus 18 at the same time, they send bus request signals REQ1, REQ2, REQ3 and REQ4 respectively to the bus arbiter 20. The bus arbiter 20 receives the bus request signals REQ1, REQ2, REQ3 and REQ4 and sends a bus grant signal GNT, according to the orders of the priorities, whereby granting the master 16a to use the shared bus 18 first to transmit data.

In the prior art, the probability that the central processing unit 12 uses the shared bus 18 is unpredictable. For example, the probability is relatively high when the central processing unit 12 executes codes having many reading or writing instructions. On the contrary, the probability is relatively low when the central processing unit 12 executes codes having few reading or writing instructions. Therefore, the priority of the central processing unit 12 is generally set to be lower than that of the master 16a whereby preventing the real-time master 16a from having problems of improper operations. In other words, if the priority of the central processing unit 12 is set to be higher than that of the master 16a having real-time processing needs, then the master 16a may operate improperly due to not being able to use the shared bus 18 timely to transmit data while the central processing unit 12 occupies the shared bus 18 constantly. For example, if the master 16a is a display control circuit and does not possess the highest priority for using the shared bus 18 to transmit data, then it may cause a display device controlled thereby to be unable to display a complete image.

However, when the priority of the central processing unit 12 is set to be lower than that of the real-time master 16a, there are still some disadvantages such as the following:

If the central processing unit 12 executes an instruction, e.g. load, store, read or write instructions, for accessing the memory unit 14 and thus needs to use the shared bus 18 during the period when the real-time master 16a uses the shared bus 18 to transmit real-time data, then the central processing unit 12 has to wait until the real-time master 16a finishes the session of using the shared bus 18 to obtain the right for using the shared bus 18. Therefore, the period of time that the central processing unit 12 waits for using the shared bus 18 may reduce MIPS (million instructions per second) rate and thus affect the performance of the central processing unit 12. To be more clear, a general formula for the MIPS rate of the central processing unit 12 is presented below:

MIPS=F/(P*C+(1−P)*I) (1)

wherein “F” represents clock speed of the central processing unit 12;

“P” represents cache miss ratio;

“C” represents the cycle number that the central processing unit 12 needs to wait for while a cache miss occurs;

“I” represents the cycle number that the central processing unit 12 needs for executing each instruction.

In the general formula (1), it could be understood that when the period of time the central processing unit 12 waits for using the shared bus 18 increases, the cycle number C will increase correspondingly such that the MIPS rate reduces.

### SUMMARY OF THE INVENTION

It is an object of the present invention to provide a system and a method for bandwidth sharing in busses so as to increase the MIPS rate of a central processing unit.

In order to achieve the above object, the present invention provides a system for bandwidth sharing in busses, which comprises a shared bus, a timer for counting a predetermined period of time, a real-time master having a priority to use the shared bus and a central processing unit having a priority, which is higher than that of the real-time master, to use the shared bus, wherein the central processing unit sends a predetermined number of bus request signals during the predetermined period of time whereby requesting to use the shared bus to transmit data.

In one embodiment of the present invention, a time interval between two consecutive bus request signals sent by the central processing unit is limited to be equal to or larger than the predetermined period of time such that the probability that the central processing unit uses the shared bus is predictable.

In another embodiment of the present invention, the system further comprises a counter for counting the number of the bus request signals sent by the central processing unit during the predetermined period of time, wherein the number of the bus request signals sent by the central processing unit during the predetermined period of time is limited to a predetermined number such that the probability that the central processing unit uses the shared bus is predictable.

The system according to the present invention further comprises a bus arbiter, which is for sending bus grant signals to respond to the bus request signals whereby granting the central processing unit to use the shared bus.

In one alternative embodiment of the present invention, a time interval between two consecutive bus grant signals sent by the bus arbiter is limited to be equal to or larger than the predetermined period of time such that the probability that the central processing unit uses the shared bus is predictable.

In another alternative embodiment of the present invention, the system further comprises a counter for counting the number of the bus grant signals sent by the bus arbiter during the predetermined period of time, wherein the number of the bus grant signals sent by the bus arbiter during the predetermined period of time is limited to a predetermined number such that the probability that the central processing unit uses the shared bus is predictable.

The present invention also provides a method for bandwidth sharing in busses, which comprises: setting a central processing unit to have a highest priority for using a shared bus; determining a predetermined period of time; and sending a predetermined number of bus request signals by the central processing unit during the predetermined period of time for requesting to use the shared bus to transmit data.

The present invention also provides a method for bandwidth sharing in busses, which comprises: setting a central processing unit to have a highest priority for using a shared bus; determining a predetermined period of time; sending a plurality of bus request signals by the central processing unit for requesting to use the shared bus to transmit data; and sending a predetermined number of bus grant signals by a bus arbiter during the predetermined period of time for responding to the bus request signals whereby granting the central processing unit to use the shared bus.

The system and the method according to the present invention, the probability that the central processing unit uses the shared bus is predictable such that the real-time master can still timely use the shared bus to transmit data and thus prevent the problems of improper operations while the MIPS rate of the central processing unit is effectively increased.

### BRIEF DESCRIPTION OF THE DRAWINGS

Other objects, advantages, and novel features of the present invention will become more apparent from the following detailed description when taken in conjunction with the accompanying drawings.

FIG. 1 shows a circuit block diagram of a conventional system 10 for bandwidth sharing in a shared bus.

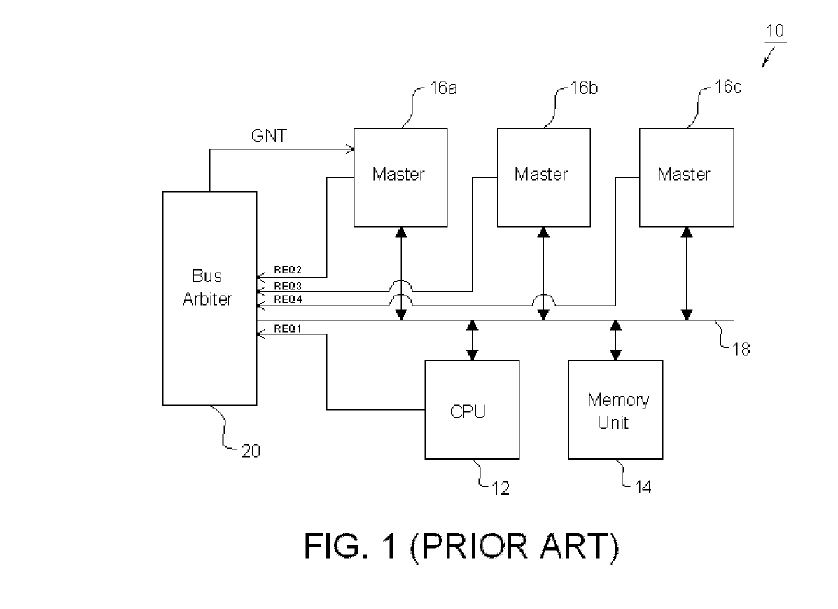

FIG. 2 shows a circuit block diagram of a system for bandwidth sharing in busses according to one embodiment of the present invention.

FIG. 3 shows the bus request signals REQ1 consecutively sent by the central processing unit shown in FIG. 2.

FIG. 4 shows a circuit block diagram of a system for bandwidth sharing in busses according to one alternative embodiment of the present invention.

FIG. 5 shows the bus grant signals GNT consecutively sent by the bus arbiter shown in FIG. 4.

FIG. 6 shows a circuit block diagram of a system for bandwidth sharing in busses according to another embodiment of the present invention.

FIG. 7 shows the bus request signals REQ1 consecutively sent by the central processing unit shown in FIG. 6.

FIG. 8 shows a circuit block diagram of a system for bandwidth sharing in busses according to another embodiment of the present invention.

FIG. 9 shows the bus grant signals GNT consecutively sent by the bus arbiter shown in FIG. 8.

### DETAILED DESCRIPTION OF THE PREFERRED EMBODIMENT

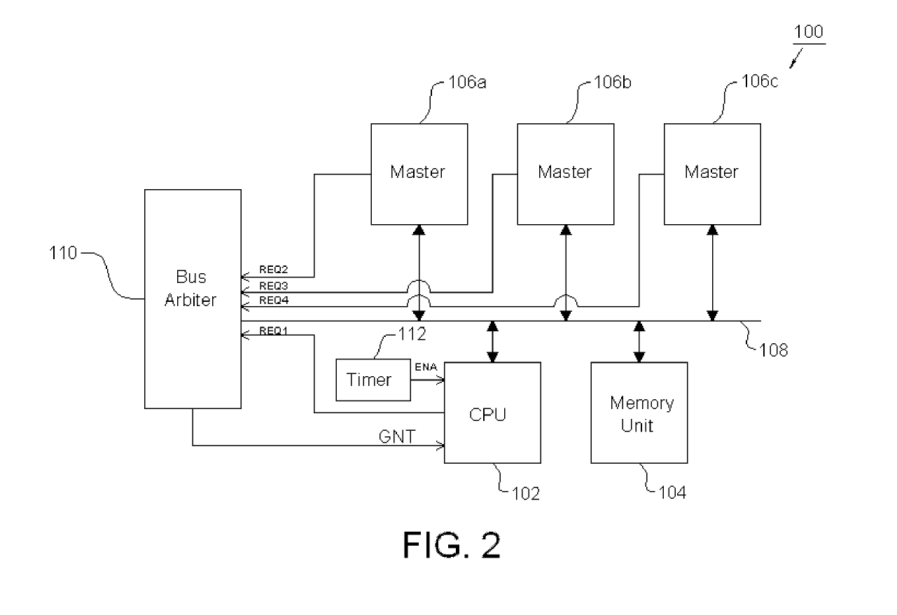

FIG. 2 shows a circuit block diagram of a system 100 for bandwidth sharing in busses according to one embodiment of the present invention. The system 100 is preferably implemented in a system on chip (SOC) and includes a central processing unit (CPU) 102, a memory unit 104, a plurality of masters 106a, 106b and 106c, a shared bus 108, a bus arbiter 110 and a timer 112. The central processing unit 102, the memory unit 104 and the masters 106a, 106b and 106c are connected to the shared bus 108 and transmit data through the shared bus 108. The shared bus 108 is a priority-based shared bus, and the central processing unit 102 and the masters 106a, 106b and 106c have different priorities to use the shared bus 108. The bus arbiter 110 is for arbitrating the right for using the shared bus 108 among the central processing unit 102 and the masters 106a, 106b and 106c according to the ranking orders of the priorities of the central processing unit 102 and the masters 106a, 106b and 106c. The timer 112 is for counting a predetermined period of time T, and sends an enabling signal ENA to the central processing unit 102 after finishing the counting of the predetermined period of time T. The predetermined period of time T can be the time that the timer 112 spends for counting upward (or downward) from an initial value, e.g. 0 (or 99), to a predetermined value, e.g. 99 (or 0).

In this embodiment, each of the masters 106a, 106b and 106c represents a unit having the ability to access memories or peripheral devices and can complete data accessing operations by itself without the intervention of any central processing unit, e.g. the central processing unit 102. In addition, each of masters 106a, 106b and 106c can be any control circuit in peripheral devices such as DVD players, monitors, hard disks, network devices etc., and includes a direct memory access (DMA) controller respectively, for controlling its data transmission with other units, which are connected to the shared bus 108.

In the system 100 according to one embodiment of the present invention, the central processing unit 102 has the highest priority for using the shared bus 108. The master 106a is a master having real-time processing needs (hereinafter real-time master), and has a second highest priority for using the shared bus 108. The masters 106b and 106c are masters having no real-time processing needs and have the lowest priority for using the shared bus 108. When the central processing unit 102 and the masters 106a, 106b and 106c are in need of the shared bus 108 at the same time, they will send bus request signals REQ1, REQ2, REQ3 and REQ4 respectively to the bus arbiter 110. Next, the bus arbiter 110 receives the bus request signals REQ1, REQ2, REQ3 and REQ4 and grants the right of using the shared bus 108 according to the ranking orders of the priorities of the central processing unit 102 and the masters 106a, 106b and 106c, to the one having the highest priority. In this embodiment, the central processing unit 102 has the highest priority; therefore, after receiving the bus request signals REQ1, REQ2, REQ3 and REQ4, the bus arbiter 110 first sends a bus grant signal GNT to respond to the bus request signal REQ1 sent by the central processing unit 102 whereby granting the central processing unit 102 to use the shared bus 108 to transmit data first. When the central processing unit 102 finishes using the shared bus 108, the bus arbiter 110 then sends other bus grant signals GNT respectively to respond to the bus request signals REQ2, REQ3 and REQ4 whereby granting the masters 106a, 106b and 106c to use the shared bus 108 to transmit data.

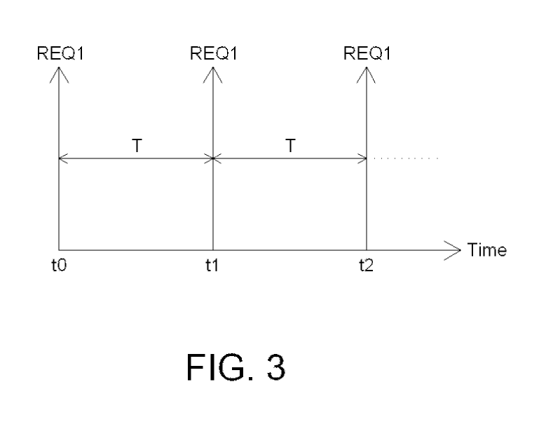

As shown in FIG. 2 and FIG. 3, the timer 112 begins to count the predetermined period of time T after the central processing unit 102 sends a bus request signal REQ1, e.g. the bus request signal REQ1 sent at time t0 shown in FIG.3. When the timer 112 finishes counting the predetermined period of time T, it sends an enabling signal ENA to the central processing unit 102 for enabling the central processing unit 102 to send the next bus request signal REQ1, e.g. the bus request signal REQ1 sent at time t1 shown in FIG. 3. In this embodiment, after sending a bus request signal REQ1, the central processing unit 102 needs to wait until the timer 112 finishes counting the predetermined period of time T and receives the enabling signal ENA in order to send the next bus request signal REQ1 to the bus arbiter 110. Therefore, the time interval between two consecutive bus request signals REQ1 sent by the central processing unit 102 is limited by the predetermined period of time T; that is, the time interval between two consecutive bus request signals REQ1 is limited to be equal to or larger than the predetermined period of time T such that the probability that the central processing unit 102 uses the shared bus 108 is predictable. Take FIG. 3 for example, the central processing unit 102 can be predicted to send at most three bus request signals REQ1, i.e. the bus request signals REQ1 sent at time t0, t1 and t2 shown in FIG. 3, to the bus arbiter 110 within the period of time between time t0 and t2. In addition, when the bus arbiter 110 receives a bus request signal REQ1 every time, it sends a corresponding bus grant signal GNT to respond to the received bus request signal REQ1 whereby granting the central processing unit 102 to use the shared bus 108 to transmit data.

In this embodiment, the probability that the central processing unit 102 uses the shared bus 108 is predictable. Therefore, when the priority of the central processing unit 102 is set to be higher than that of the master 106a having real-time processing needs, the real-time master 106a can be designed or scheduled according to the probability that the shared bus 108 is used by the central processing unit 102, whereby preventing the problems of improper operations caused by not timely using the shared bus 108 to transmit data. For example, when the probability that the central processing unit 102 uses the shared bus 108 is predictable, the real-time master 106a can select a buffer having an appropriate size according to the probability that the shared bus 108 is used by the central processing unit 102, whereby preventing the problems of improper operations caused by not timely using the shared bus 108 to transmit data.

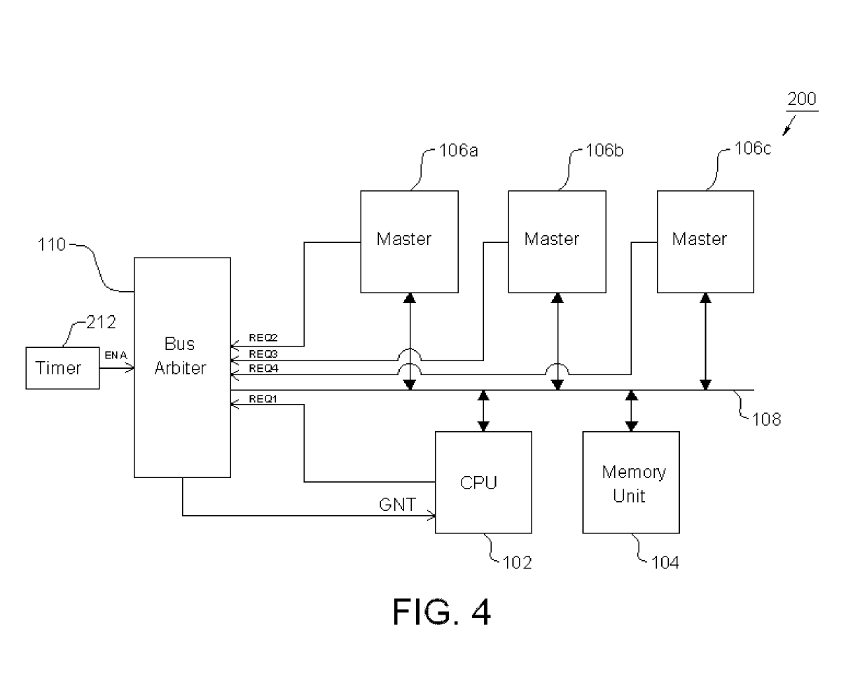

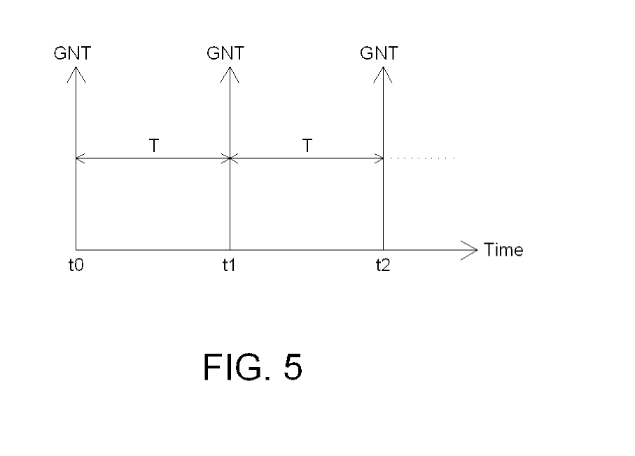

FIG. 4 shows a circuit block diagram of a system 200 for bandwidth sharing in busses according to one alternative embodiment of the present invention. The system 200 is preferably implemented in a system on chip (SOC). In FIG. 4, the elements, which are identical to those shown in FIG. 2, are indicated by the same numerals and will not be described in detail. The main difference between the system 200 and the system 100 shown in FIG. 2 is that the bus arbiter 110 can limit the time interval between two consecutive bus grant signals GNT, which are to be sent to the central processing unit 102, by a predetermined period of time T counted by a timer 212 and shown in FIG. 5; that is, the time interval between two consecutive bus grant signals GNT is limited to be equal to or larger than the predetermined period of time T such that the probability that the central processing unit 102 uses the shared bus 108 is predictable, whereby preventing the master 106a from operating improperly due to not timely using the shared bus 108 to transmit data.

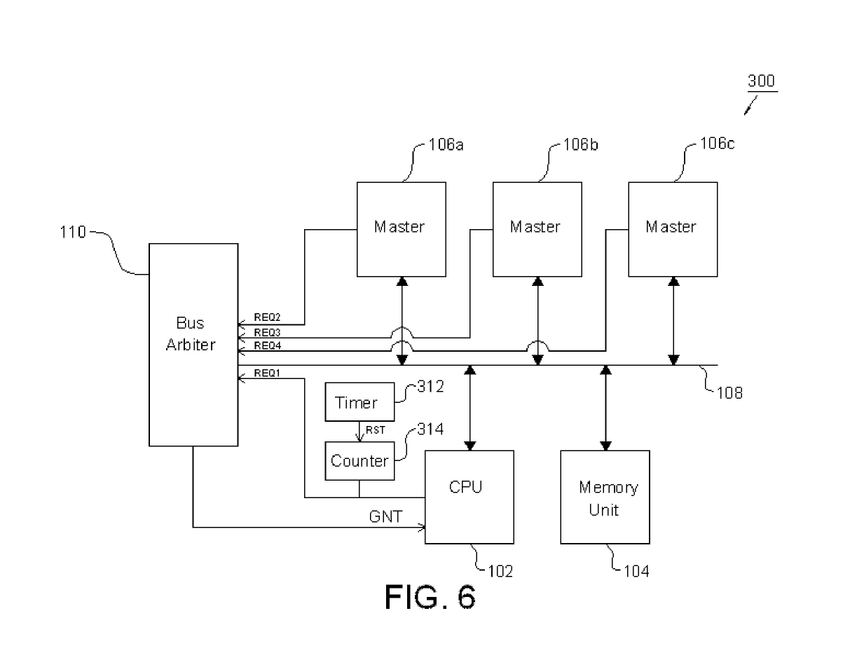

FIG. 6 shows a circuit block diagram of a system 300 for bandwidth sharing in busses according to another embodiment of the present invention. The system 300 is preferably implemented in a system on chip. In FIG. 6, the elements, which are identical to those shown in FIG. 2, are indicated by the same numerals and will not be described in detail. The main difference between the system 300 and the system 100 shown in FIG. 2 is that the system 300 includes a timer 312 and a counter 314. The timer 312 is for counting a predetermined period of time T and can send a reset signal RST to the counter 314 after finishing the counting of the predetermined period of time T and then starts a re-count. The counter 314 is for counting the number of the bus request signals REQ1 sent by the central processing unit 102 during the predetermined period of time T and then re-counting it after receiving the reset signal RST.

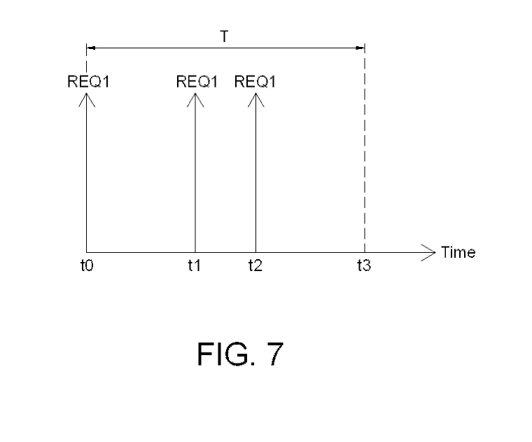

Now referring to FIG. 6 and FIG. 7, when the timer 312 counts the predetermined period of time T (e.g. time t0 to t3), the counter 314 counts the number of the bus request signals REQ1 sent by the central processing unit 102. In the system 300 of the present invention, when the counter 314 counts to a predetermined number of bus request signals REQ1, e.g. three bus request signals REQ1 at time t0, t1 and t2 shown in FIG. 7, within the predetermined period of time T, the bus arbiter 110 may adjust the priority of the central processing unit 102 to be lower than the priority of the master 106a; therefore, the master 106a obtains the right for using the shared bus 108 after the central processing unit 102 sends three bus request signals REQ1 to the bus arbiter 110. When the timer 312 finishes counting the predetermined period of time T, it begins to re-count the next predetermined period of time T and sends the reset signal RST to the counter 314 such that the counter 314 can also begin to re-count the number of the bus request signals REQ1 sent by the central processing unit 102 during the next predetermined period of time T. Furthermore, when the timer 312 finishes counting the predetermined period of time T, the arbiter 110 may adjust the priority of the central processing unit 102 to be the highest such that the central processing unit 102 can have the right for using the shared bus 108 to transmit data first.

In this embodiment, the number of the bus request signals REQ1 sent by the central processing unit 102 within the predetermined period of time T is limited to a predetermined number (at least one); therefore, the probability that the central processing unit 102 uses the shared bus 108 is predictable such that the real-time master 106a can be designed or scheduled according to the probability that the shared bus 108 is used by the central processing unit 102, whereby preventing the problems of improper operations caused by not timely using the shared bus 108 to transmit data.

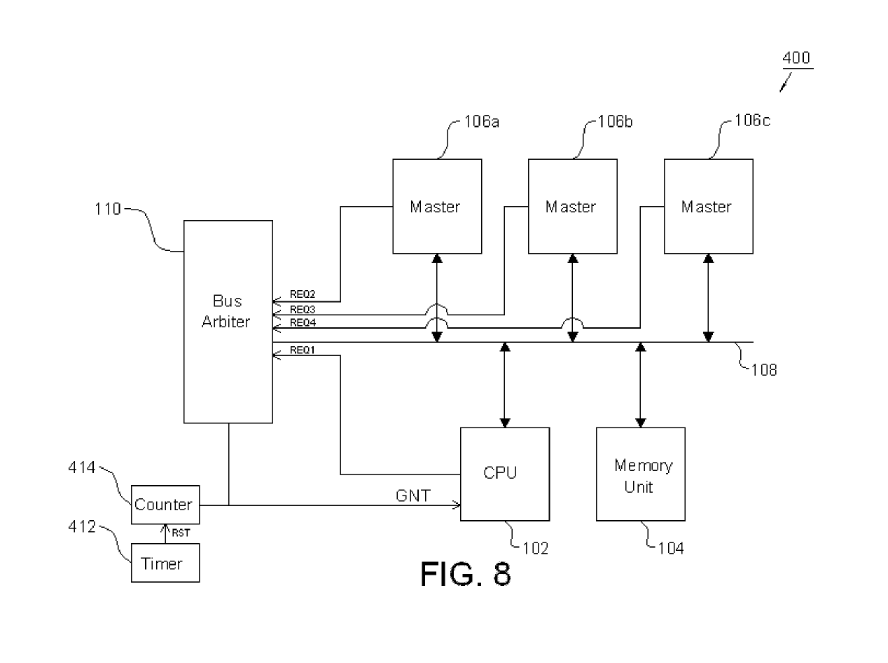

FIG. 8 shows a circuit block diagram of a system 400 for bandwidth sharing in a shared bus according to another alternative embodiment of the present invention. The system 400 is preferably implemented in a system on chip. In FIG. 8, the elements, which are identical to those shown in FIG. 2, are indicated by the same numerals and will not be described in detail. In FIG. 8, the system 400 includes a timer 412 and a counter 414. The timer 412 is for counting a predetermined period of time T, and it can send a reset signal RST to the counter 414 after finishing the counting of the predetermined period of time T and then starts a re-count. The counter 414 is for counting the number of the bus grant signals GNT sent by the bus arbiter 110 to the central processing unit 102 during the predetermined period of time T and then re-counting it after receiving the reset signal RST.

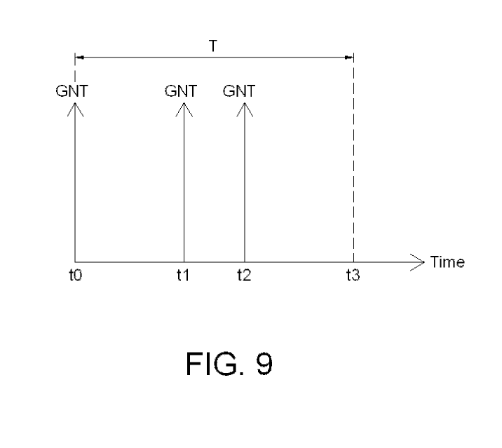

Now referring to FIG. 8 and FIG. 9, when the timer 412 counts the predetermined period of time T (e.g. time t0 to t3), the counter 414 counts the number of the bus grant signals GNT sent by the bus arbiter 110 to the central processing unit 102. In the system 400 of the present invention, when the counter 414 counts to a predetermined number of bus grant signals GNT, e.g. three bus grant signals GNT at time t0, t1 and t2 shown in FIG. 9, within the predetermined period of time T, the bus arbiter 110 may adjust the priority of the central processing unit 102 to be lower than the priority of the master 106a; therefore, the master 106a can obtain the right for using the shared bus 108 during the period from time t2 to t3 after the bus arbiter 110 sends three bus grant signals GNT to the central processing unit 102 consecutively. When the timer 412 finishes counting the predetermined period of time T, it begins to re-count the next predetermined period of time T and sends the reset signal RST to the counter 414 such that the counter 414 can also begin to re-count the number of the bus grant signals GNT sent by the bus arbiter 110 during the next predetermined period of time T. Furthermore, when the timer 412 finishes counting the predetermined period of time T, the bus arbiter 110 may adjust the priority of the central processing unit 102 to be the highest such that the central processing unit 102 can have the right for using the shared bus 108 to transmit data first.

In this embodiment, the number of the bus grant signals GNT sent by the bus arbiter 110 within the predetermined period of time T is limited to a predetermined number (at least one); therefore, the probability that the central processing unit 102 is granted to use the shared bus 108 is predictable such that the real-time master 106a can be designed or scheduled according to the probability that the shared bus 108 is used by the central processing unit 102, whereby preventing the problems of improper operations caused by not timely using the shared bus 108 to transmit data.

In the systems 100, 200, 300 and 400 according to the embodiments of the present invention, the central processing unit 102 can utilize a direct memory access (DMA) controller (not shown) to generate and send the bus request signals REQ1 to the bus arbiter 110, and also utilize it to receive the bus grant signals GNT responded by the bus arbiter 110.

In addition, the central processing unit 102 according to the embodiments of the present invention has the highest priority for using the shared bus 108; therefore, the MIPS rate of the central processing unit 102 can be effectively increased. In addition, the probability that the central processing unit 102 uses the shared bus 108 is predictable; therefore, the real-time master 106a can still timely use the shared bus 108 to transmit data and thus prevent the problems of improper operations while the MIPS rate of the central processing unit 102 is effectively increased.

According to other embodiments of the present invention, the shared bus 108 can also be prevented from staying idle. If the shared bus 108 stays idle, then the limitation described in the above embodiments, e.g. the limitation to the number of the request signals REQ or the number of the grant signals GNT and the limitation to the time interval between two consecutive request signals REQ or between two consecutive grant signals GNT, can be cancelled. For example, the limitations can be cancelled by resetting the counter such that the central processing unit 102 can execute access operations, e.g. reading or writing operations, with its highest speed.

The method for bandwidth sharing in busses according to the present invention is by setting the priority of the central processing unit 102 to be the highest and making the probability that the central processing unit 102 uses the shared bus 108 predictable whereby achieving the object of the present invention. In addition, it should be understood that, in the above embodiments, the method for bandwidth sharing in busses according to the present invention is applied to a system for bandwidth sharing in busses in which the right for using the shared bus 108 is arbitrated based on a priority scheme. However, in other embodiments, the method for bandwidth sharing in busses according to the present invention can also be applied to a system for bandwidth sharing in busses in which the right for using the shared bus 108 is arbitrated based on a round-robin scheme or a Time Division Multiple Access (TDMA) scheme.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A system for bandwidth sharing in busses, comprising:
a shared bus;
a timer for counting a predetermined period of time;
a plurality of masters each having a priority for using the shared bus to transmit data; and
a central processing unit having a priority for using the shared bus to transmit data, wherein the priority of the central processing unit is higher than the priority of each master;
wherein the central processing unit sends a predetermined number of bus request signals during the predetermined period of time whereby requesting to use the shared bus to transmit data.

2. The system as claimed in claim 1, further comprising a bus arbiter which sends at least one bus grant signal for responding to the bus request signals whereby granting the central processing unit to use the shared bus.

3. The system as claimed in claim 2, wherein the predetermined period of time is a time interval between two consecutive bus grant signals sent by the bus arbiter.

4. The system as claimed in claim 2, further comprising a direct memory access controller wherein the central processing unit utilizes the direct memory access controller to generate the bus request signals and to receive the at least one bus grant signal.

5. The system as claimed in claim 1, wherein the predetermined number is one.

6. The system as claimed in claim 1, wherein a time interval between two consecutive bus request signals sent by the central processing unit is equal to or larger than the predetermined period of time.

7. The system as claimed in claim 2, wherein a time interval between two consecutive bus grant signals sent by the bus arbiter is equal to or larger than the predetermined period of time.

8. The system as claimed in claim 1, wherein the predetermined period of time is a time interval between two consecutive bus request signals sent by the central processing unit.

9. The system as claimed in claim 1, which is implemented in a system on chip.

10. The system as claimed in claim 1, further comprising a counter for counting the number of the bus request signals sent by the central processing unit during the predetermined period of time.

11. The system as claimed in claim 10, wherein the counter is reset while the shared bus is idle such that the central processing unit can execute access operations with its highest speed.

12. A method for bandwidth sharing in busses, comprising:
setting a central processing unit to have a highest priority for using a shared bus;
determining a predetermined period of time; and
sending a predetermined number of bus request signals by the central processing unit during the predetermined period of time for requesting to use the shared bus to transmit data.

13. The method as claimed in claim 12, further comprising:
utilizing a bus arbiter to send at least one bus grant signal for responding to the bus request signals.

14. The method as claimed in claim 12, wherein the predetermined number is one.

15. The method as claimed in claim 12, wherein a time interval between two consecutive bus request signals sent by the central processing unit is equal to or larger than the predetermined period of time.

16. The method as claimed in claim 12, wherein the predetermined period of time is a time interval between two consecutive bus request signals sent by the central processing unit.

17. The method as claimed in claim 12, which is implemented in a system on chip.

18. The method as claimed in claim 12, wherein the determining step further comprises:
utilizing a timer to count the predetermined period of time.

19. The method as claimed in claim 12, further comprising:
utilizing a counter to count the number of the bus request signals during the predetermined period of time.

20. The method as claimed in claim 19, wherein the counter is reset while the shared bus is idle such that the central processing unit can execute access operations with its highest speed.

21. A method for bandwidth sharing in busses, comprising:
setting a central processing unit to have a highest priority for using a shared bus;
determining a predetermined period of time;
sending a plurality of bus request signals by the central processing unit for requesting to use the shared bus to transmit data; and
sending a predetermined number of bus grant signals by a bus arbiter during the predetermined period of time for responding to the bus request signals whereby granting the central processing unit to use the shared bus.

22. The method as claimed in claim 21, wherein the predetermined number is one.

23. The method as claimed in claim 21, wherein a time interval between two consecutive bus grant signals sent by the bus arbiter is equal to or larger than the predetermined period of time.

24. The method as claimed in claim 21, wherein the predetermined period of time is a time interval between two consecutive bus grant signals sent by the bus arbiter.

25. The method as claimed in claim 21, which is implemented in a system on chip.

26. The method as claimed in claim 21, wherein the determining step further comprises:
utilizing a timer to count the predetermined period of time.

27. The method as claimed in claim 21, further comprising:
utilizing a counter to count the number of the bus grant signals during the predetermined period of time.

28. The method as claimed in claim 27, wherein the counter is reset while the shared bus is idle such that the central processing unit can execute access operations with its highest speed.
